(19) United States
(12) Patent Application Publication
(10) Pub. No.: US 2025/0260893 A1
(43) Pub. Date: Aug. 14, 2025

(54) COMPOSITE CONTENT CAPTURE ACROSS MULTIPLE WIRELESS DEVICES

(71) Applicant: QUALCOMM Incorporated, San Diego, CA (US)

(72) Inventors: Akash SAMBHANGI, Chennai (IN); Surendrareddy TIPPAREDDY, Hyderabad (IN); Rahul Kumar POSANAGIRI, Hyderabad (IN)

(21) Appl. No.: 18/441,705

(22) Filed: Feb. 14, 2024

(51) Int. Cl. H04N 23/60; H04N 23/661; H04N 23/698

(52) U.S. Cl. CPC H04N 23/64; H04N 23/662; H04N 23/698

(57) ABSTRACT

This disclosure provides methods, components, devices and systems for composite content capture across multiple wireless devices. Some aspects more specifically relate to establishing or action performed in a wireless network including a primary wireless device and one or more secondary wireless devices. In some examples, each secondary wireless devices may transmit images to the primary wireless device based on an indication of one or more content capture parameters. The primary wireless device may determine an alignment between the images of the primary wireless device and the one or more secondary wireless devices, and may transmit adjustment information indicating one or more respective adjustment parameters (such as rotate, tilt, move, or the like) to at least some of the secondary wireless devices. In some examples, the primary wireless device may generate a composition of the adjusted images of each of the secondary devices and the image of the primary wireless device.

### TECHNICAL FIELD

This disclosure relates generally to wireless communication and, more specifically, to composite content capture across multiple wireless devices.

### DESCRIPTION OF THE RELATED TECHNOLOGY

A wireless network, such as a local area network (WLAN), may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

In some wireless networks, such as WLANs, a STA may use one or more sensors to capture content (such as one or more images or frames of video).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a first wireless communication device. The first wireless communication device includes a processing system that includes processor circuitry and memory circuitry that stores code, the processing system configured to cause the first wireless communication device to: establish a wireless communication link with a second wireless communication device based on a composite content capture associated with the first wireless communication device and the second wireless communication device; receive, via the wireless communication link and according to one or more content capture parameters associated with the first wireless communication device and the second wireless communication device, a first image captured by a sensor at the second wireless communication device; and transmit, via the wireless communication link based on one or more alignment differences between the first image and a second image, adjustment information that indicates one or more adjustment parameters for adjustment of a position of the sensor of the second wireless communication device based on the one or more alignment differences between the first image and the second image.

In some examples, the processing system is further configured to cause the first wireless communication device to: receive, via the wireless communication link, at least one capability message including one or more parameters associated with the sensor at the second wireless communication device; and transmit, via the wireless communication link based on the one or more parameters indicated via the capability message, a content capture configuration message including the one or more content capture parameters for the composite content capture, where the first image captured by the sensor at the second wireless communication device is based on the content capture configuration message.

In some examples, the processing system is further configured to cause the first wireless communication device to: receive, via the wireless communication link based on the adjustment information, an adjustment of the first image associated with the second wireless communication device; and generate a composite image based on the second image and the adjustment of the first image.

Another innovative aspect of the subject matter described in this disclosure can be implemented in a second wireless communication device. The second wireless communication device includes a processing system that includes processor circuitry and memory circuitry that stores code, the processing system configured to cause the second wireless communication device to: establish a wireless communication link with a first wireless communication device based on a composite content capture associated with the first wireless communication device and the second wireless communication device; transmit, via the wireless communication link and according to one or more content capture parameters associated with the first wireless communication device and the second wireless communication device, a first image captured by a sensor at the second wireless communication device; and receive, via the wireless communication link based on one or more alignment differences between the first image and a second image, adjustment information that indicates one or more adjustment parameters for adjustment of a position of the sensor at the second wireless communication device based on the one or more alignment differences between the first image and the second image.

In some examples, the processing system is further configured to cause the second wireless communication device to: output, to a user interface of the second wireless communication device, the adjustment information; and transmit, via the wireless communication link based on the adjustment information, an adjustment of the first image associated with the second wireless communication device, the adjustment of the first image based on outputting the adjustment information via the user interface.

Another innovative aspect of the subject matter described in this disclosure can be implemented in a method for wireless communication by a first wireless communication device. The method includes establishing a wireless communication link with a second wireless communication device based on a composite content capture associated with the first wireless communication device and the second wireless communication device; receiving, via the wireless communication link and according to one or more content capture parameters associated with the first wireless communication device and the second wireless communication device, a first image captured by a sensor at the second wireless communication device; and transmitting, via the wireless communication link based on one or more alignment differences between the first image and a second image, adjustment information that indicates one or more adjustment parameters for adjustment of a position of the sensor of the second wireless communication device based on the one or more alignment differences between the first image and the second image.

Another innovative aspect of the subject matter described in this disclosure can be implemented in a method for wireless communication by a second wireless communication device. The method includes establishing a wireless communication link with a first wireless communication device based on a composite content capture associated with the first wireless communication device and the second wireless communication device; transmitting, via the wireless communication link and according to one or more content capture parameters associated with the first wireless communication device and the second wireless communication device, a first image captured by a sensor at the second wireless communication device; and receiving, via the wireless communication link based on one or more alignment differences between the first image and a second image, adjustment information that indicates one or more adjustment parameters for adjustment of a position of the sensor at the second wireless communication device based on the one or more alignment differences between the first image and the second image.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example of a signaling diagram that supports composite content capture across multiple wireless devices.

FIG. 3 shows an example of a wireless device configuration that supports composite content capture across multiple wireless devices.

FIG. 4 shows an example of a process flow that supports composite content capture across multiple wireless devices.

FIG. 5 shows a block diagram of an example wireless communication device that supports composite content capture across multiple wireless devices.

FIGS. 6 through 8 show flowcharts illustrating example processes performable by or at a first wireless device that supports composite content capture across multiple wireless devices.

FIG. 9 shows a flowchart illustrating an example process performable by or at a second wireless device that supports composite content capture across multiple wireless devices.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others. The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IoT) network.

Various aspects relate generally to composite content capture across multiple wireless devices in a wireless network. Some aspects more specifically relate to composite content capture based on an improved alignment of sensors of one or more wireless devices in accordance with composite content capture signaling exchanged between the multiple wireless devices. In some examples, multiple wireless devices may establish or be part of a network including a primary wireless device (such as a parent device) and one or more secondary wireless devices (such as child devices). In some examples, the multiple wireless devices may communicate via a distributed coordination function (DCF), or other type of wireless network connection. The one or more secondary wireless devices may communicate content capture parameters (such as resolution, frame rate, tone, or the like) that are supported by the respective secondary wireless devices to the primary wireless device. Based on the supported content capture parameters, the primary wireless device may transmit a configuration message to the one or more secondary wireless devices indicating which one or more parameters to use. Each of the one or more secondary wireless devices may transmit one or more images obtained in accordance with the parameters to the primary wireless device. The images may be, for example, photos, videos, or other streams of pixelated data, among other examples.

In some examples, the primary wireless device may apply an image alignment algorithm (such as fast library for approximate nearest neighbors (FLANN) or brute-force calculation) to determine an alignment between the images of the primary wireless device and the one or more secondary wireless devices. Based on the image alignment algorithm, the primary wireless device may transmit adjustment information that indicates one or more adjustment parameters (such as rotate, tilt, move, or the like) to the one or more secondary wireless devices. The one or more secondary wireless devices may receive the adjustment information and perform one or more adjustment actions in response. In some examples, a user of the secondary wireless devices may adjust a position of the secondary wireless device, or the secondary wireless device may adjust a position or an image automatically, or both. The one or more secondary wireless devices may obtain further images after the adjustment and may transmit the images to the primary wireless device. In some examples, the primary wireless device may generate a composition of the adjusted images of each of the one or more secondary devices and the image of the primary wireless device (such as to capture 360 degree content, panoramic content, or the like).

Particular aspects of the subject matter described in this disclosure can be implemented to realize one or more of the following potential advantages. In some examples, by transmitting the adjustment information and receiving the adjusted images, the described techniques can be used to improve the alignment between the images (such as compared to wireless communication networks that do not exchange adjustment information between devices) by facilitating the exchanging of relative information related to the devices and the images. In some examples, the improved alignment between images may further improve accuracy and quality of the resulting composite image.

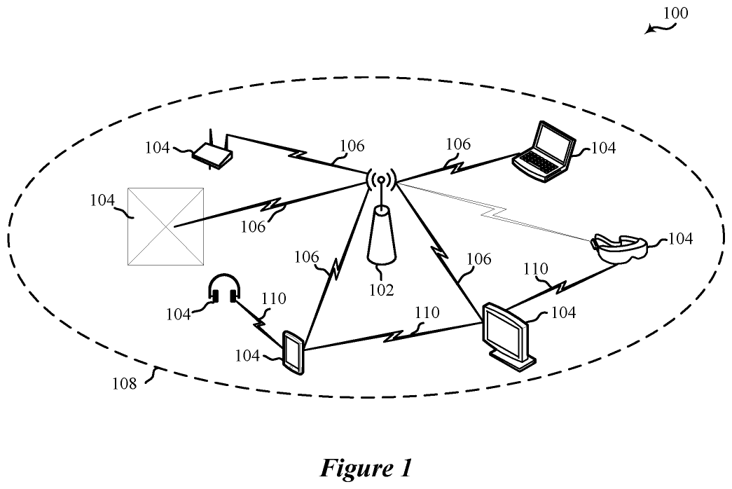

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bc, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (such as TVs, computer monitors or video gaming consoles), video game controllers, navigation systems, music or other audio or stereo devices, remote control devices, printers, kitchen appliances (including smart refrigerators) or other household appliances, key fobs (such as for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (such as the 2.4 GHz, 5 GHZ, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

In some examples, the STAs 104 and the APs 102 may wirelessly communicate with one another via one or more communication links 106 (such as an access link) using resources associated with one or more carriers. The term “carrier” may refer to a set of RF spectrum resources having a defined physical layer structure for supporting the communication links 106. For example, a carrier used for a communication link 106 may include a portion of a RF spectrum band (such as a bandwidth part (BWP)) that is operated according to one or more physical layer channels for a given radio access technology (such as LTE, LTE-A, LTE-A Pro, NR). Each physical layer channel may carry acquisition signaling (such as synchronization signals, system information), control signaling that coordinates operation for the carrier, user data, or other signaling. The wireless communication network 100 may support communication with a STA 104 using carrier aggregation or multi-carrier operation. A STA 104 may be configured with multiple downlink component carriers and one or more uplink component carriers according to a carrier aggregation configuration. Carrier aggregation may be used with both frequency division duplexing (FDD) and time division duplexing (TDD) component carriers. Communication between an AP 102 and other devices may refer to communication between the devices and any portion (such as entity, sub-entity) of an AP 102. For example, the terms “transmitting,” “receiving,” or “communicating,” when referring to an AP 102, may refer to any portion of an AP 102 (such as a base station, a CU, a DU, a RU) of a RAN communicating with another device (such as directly or via one or more other APs 102).

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. In some examples, one or more STAs 104 (such as UEs) of a group that are performing P2P communications may be within a coverage area of an AP 102 (such as a base station, an RU), which may support aspects of such P2P communications being configured by (such as scheduled by) the AP 102. In some examples, one or more STAs 104 of such a group may be outside the coverage area of an AP 102 or may be otherwise unable to or not configured to receive transmissions from an AP 102. In some examples, groups of the STAs 104 communicating via P2P communications may support a one-to-many (1:M) system in which each STA 104 transmits to each of the other STAs 104 in the group. In some examples, an AP 102 may facilitate the scheduling of resources for P2P communications. In some other examples, P2P communications may be carried out between the STAs 104 without an involvement of an AP 102. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHz, 6 GHZ, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHZ-7.125 GHZ), FR2 (24.25 GHZ-52.6 GHz), FR3 (7.125 GHZ-24.25 GHz), FR4a or FR4-1 (52.6 GHz-71 GHz), FR4 (52.6 GHz-114.25 GHZ), and FR5 (114.25 GHZ-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (such as a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHZ, 160 MHz, 240 MHZ, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (such as for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (such as UHR- or IEEE 802.11bn-compatible) devices for opportunistic access to spectrum that may be otherwise under-utilized.

In some examples, devices in the wireless communication network 100 may support multi-device composite content capture. Some aspects more specifically relate to composite content capture based on an improved alignment of sensors of each wireless device in accordance with composite content capture signaling exchanged between the multiple wireless devices. In some examples, multiple wireless devices may establish a network including a primary wireless device (such as a parent device) and one or more secondary wireless devices (such as child devices). In some examples, the multiple wireless devices may communicate via a DCF, or other type of wireless network connection. The wireless devices may represent examples of STAs 104, APs 102, or some other type of wireless device. In some examples, the primary wireless device may be an AP 102, and the secondary wireless devices may be STAs 104, or some other types of devices. The one or more secondary wireless devices may communicate, via respective direct communication links 110, content capture parameters (such as resolution, frame rate, tone, or the like) that are supported by the respective secondary wireless devices to the primary wireless device. Based on the supported content capture parameters, the primary wireless device may transmit a configuration message to the one or more secondary wireless devices indicating which parameters to use. Each of the one or more secondary wireless devices may transmit images obtained in accordance with the parameters to the primary wireless device. The images may be, for example, photos, videos, or other streams of pixelated data, among other examples.

In some examples, the primary wireless device may apply an image alignment algorithm (such as fast library for approximate nearest neighbors (FLANN) or brute-force calculation) to determine an alignment between the images of the primary wireless device and the one or more secondary wireless devices. Based on the image alignment algorithm, the primary wireless device may transmit adjustment information that indicates one or more adjustment parameters (such as rotate, tilt, move, or the like) to the one or more secondary wireless devices. The one or more secondary wireless devices may receive the adjustment information and perform one or more adjustment actions in response. In some examples, a user of the secondary wireless devices may adjust a position of the secondary wireless device, or the secondary wireless device may adjust a position automatically, or both. The one or more secondary wireless devices may obtain further images after the adjustment and may transmit the images to the primary wireless device. In some examples, the primary wireless device may generate a composition of the adjusted images of each of the one or more secondary devices and the image of the primary wireless device (such as to capture 360 degree content, panoramic content, or the like).

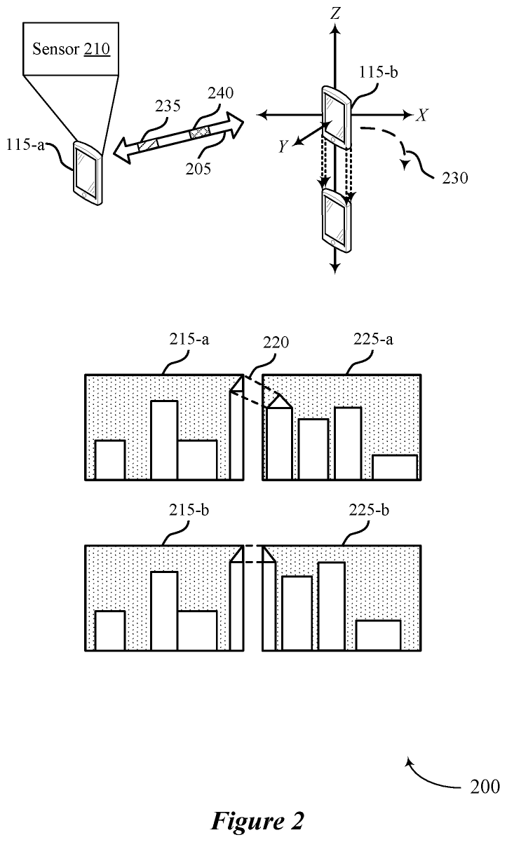

FIG. 2 shows an example of a signaling diagram 200 that supports composite content capture across multiple wireless devices. The signaling diagram 200 may implement or be implemented by aspects of the wireless communication network 100. For example, the signaling diagram 200 illustrates signaling exchanged between a parent wireless device 115-a and a child wireless device 115-b, which may represent examples of STAs, UEs, network entities, APs, or other types of wireless devices, as described with reference to FIG. 1. In some examples, the images 215 and 225 may be obtained by the parent wireless device 115-a and the child wireless device 115-b, respectively. For example, each wireless device 115 may include one or more sensors 210 that may capture one or more images (such as the image 215 or the image 225).

In some wireless communications systems, specialized equipment may capture video or image content. For example, to capture 360 degree video or images, additional lenses may be attached to a wireless device 115 (such as an AP 102 or a STA 104). In some examples, an application may receive a feed from a first sensor 210 (such as a front camera) and a second sensor 210 (such as a back camera) of the wireless device 115 to produce a 360 degree output (such as a video or image of all directions of the wireless device 115). In such examples, a field-of-view (FOV) of the first sensor 210 and an FOV of the second sensor 210 may not be wide enough to create a sufficient area of intersection (such as to align the captured video or image of each sensor 210). Additionally, or alternatively, frames (such as from a video or an image) may be captured by different devices with a sufficient area of intersection. However, each device may have no context of what frames are being captured by other devices, and each frame captured by the devices may not be aligned.

The signaling diagram 200 may support composite content capture across multiple wireless devices based on an improved alignment of the sensors 210 of each wireless device. For example, a parent wireless device 115-a may define a network of wireless devices including one or more child wireless devices 115-b. The parent wireless device 115-a may establish at least one two-way communication link 205. In some examples, the parent wireless device 115-a may establish the two-way communication link 205 between the parent wireless device 115-a and a quantity (such as all) of available child wireless devices 115-b. For example, each child wireless device 115-b may have a respective two-way communication link 205 with the parent wireless device 115-a. In some examples, the two-way communication link 205 may be established via a DCF. Additionally, or alternatively, the two-way communication link 205 may be established via some other communication protocol or wireless communication network. In some examples, the parent wireless device 115-a may support composite content capture based on three steps: connect and establish, correct and setup, and record and process.

In some examples, a wireless device 115 may be selected from a group of wireless devices 115 to be the parent wireless device 115-a. For example, the wireless device 115 may be selected based on a user selection, a processing capability of the wireless device 115, an image storage capability of the wireless device 115, a sensor 210 of the wireless device 115, or any combination thereof. In some examples, the parent wireless device 115-a may be responsible for at least a portion of processing associated with the composite content capture. In some examples, the other wireless devices 115 of the group of wireless devices may be one or more child wireless devices 115-b. In some examples, the parent wireless device 115-a may assign each child wireless device 115-b a sub identifier (ID) (such as c1, c2, . . . cn) to determine an order of position and image processing. The parent wireless device 115-a may connect to the one or more child wireless devices 115-b and establish the two-way communication link 205 between each device.

In some examples, each child wireless device 115-b may transmit a respective capability message 235 to the parent wireless device 115-a via the communication link 205. The capability message 235 may indicate one or more sensor capabilities supported by the respective device 115. In some examples, the parent wireless device 115-a may provide a user of the parent wireless device 115-a with options for one or more sensor parameters. For example, the parent wireless device 115-a may output an indication of the one or more sensor parameters to a user via a user interface. The parameters may include tone, aspect ratio, resolution, frames per second (FPS), or the like. In some examples, the parameters may be based on the sensor capabilities of each of the one or more child wireless devices 115-b. For example, a first child wireless device 115-b may support a resolution of 1920×1080 pixels at a sensor 210 and a second child wireless device 115-b may support a resolution of 2560×1440 pixels at a sensor 210. In this example, the parent wireless device 115-a may provide the user with a resolution of 1920×1080 pixels because not all of the wireless devices 115 support the resolution of 2560×1440 pixels. In some examples, the options for the one or more sensor parameters provided to the user of the parent wireless device 115-a may apply to the parent wireless device 115-a and to the one or more child wireless devices 115-b.

In some examples, the parent wireless device 115-a and each of the one or more child wireless devices 115-b may capture content via one or more sensors 210 (such as one or more sensors of one or more cameras). For example, the parent wireless device 115-a may capture a first image 215-a and a child wireless device 115-b may capture a first image 225-a. In some examples, the parent wireless device 115-a and each of the one or more child wireless devices 115-b may capture the content according to the one or more sensor parameters. In some aspects, the parent wireless device 115-a and each of the one or more child wireless devices 115-b may perform image preprocessing.

In some examples, the one or more child wireless devices 115-b may transmit video, continuous images, periodic images, or the like (such as a live stream of video) of captured content to the parent wireless device 115-a via the communication link 205. For example, the child wireless device 115-b may transmit the first image 225-a to the parent wireless device 115-a as part of a continuous stream of images (such as a frame in a video) based on capturing the first image 225-a with a sensor 210 of the child wireless device 115-b. In some examples, one or more features (such as edges of images, pixels of images, or the like) of images (such as the first image 215-a and the first image 225-a) may not align between images of adjacent devices. For example, a distance between pixels may exceed a threshold (such as a threshold selected by the parent wireless device 115-a).

In some examples, the parent wireless device 115-a may perform an edge detection algorithm on the one or more images received from each of the one or more child wireless devices 115-b and one or more images captured by the sensor 210 of the parent wireless device 115-a. Additionally, or alternatively, the parent wireless device 115-a may calculate a distance between features of each of the one or more images (such as using brute force or FLANN). For example, the edge detection algorithm may detect, or the parent wireless device 115-a may calculate, one or more alignment differences 220 between the first image 215-a and the first image 225-a. An alignment difference 220 may correspond to a difference in relative pixel location within an image. For example, the alignment difference 220 illustrated in FIG. 2 may represent a difference between a location of a first object in the first image 215-a and a location of the first object in the first image 225-a. That is, the first object may be repeated or otherwise duplicated across the two images, and the alignment difference 220 may correspond to an indication or measurement of the difference in pixel alignment. In some examples, the distance calculation may be based on the edge detection algorithm. For example, the edge detection algorithm may identify one or more alignment differences 220 between images and the parent wireless device 115-a may calculate one or more distances based on the one or more alignment differences 220. In some examples, a distance between the misaligned pixels may be translated to a physical distance (such as in centimeters or inches). The physical distance may represent a corrective movement in position of the sensors 210 at the one or more child wireless devices 115-b to align the images.

In some examples, the parent wireless device 115-a may communicate an indication of respective corrective movement to the respective one or more child wireless devices 115-b via the communication link 205. For example, each of the one or more child wireless devices 115-b may receive a respective adjustment information indication 240 based on respective alignment differences. That is, each of the child wireless devices 115-b may move differently to achieve an alignment across images. The adjustment information indication 240 may indicate a spatial movement of the one or more child wireless devices 115-b along an X axis, a Y axis, a Z axis, or any combination thereof. For example, a rotate indication 230 may indicate child wireless device 115-b to rotate around the X axis and Y axis (such as to align the images), and a translation indication may indicate the child wireless device 115-b to move along a certain axis, such as move down the Z axis as illustrated by the dashed arrows in FIG. 2.

In some examples, the child wireless device 115-b may output, to a user interface of the device 115-b, an indication to perform the corrective movement according to the adjustment information indication 240. For example, the user may obtain an interactive arrow on a user interface of each child wireless device 115-b that depicts a direction and magnitude to move the child wireless device 115-b (such as the arrow may represent the rotate indication 230). In some examples, the arrow may grow or shrink as the user moves the one or more child wireless devices 115-b away or towards the direction to correct the image. In some aspects, the indication may be aided by gyroscopic and accelerometer sensors in the child wireless device 115-b.

In some examples, a setup threshold may be satisfied based on each sensor 210 of the one or more child wireless devices 115-b satisfying a position according to the adjustment information indication 240. In a non-limiting example, the parent wireless device 115-a may transmit an indication for the child wireless device 115-b to move along the Z axis based one the one or more alignment differences 220. Based on the movement along the Z axis, a second image 215-b of the parent wireless device 115-a and a second image 225-b of the child wireless device 115-b may align, and the setup threshold may be satisfied. The second image 215-b of the parent wireless device 115-a may be the same as the first image 215-a of the parent wireless device 115-a at a second time. For example, the parent wireless device 115-a may, in some examples, refrain from adjusting a physical position of a sensor 210 at the parent wireless device 115-a and may instead instruct the child wireless device 115-b to do the position adjustment. In some examples, the setup threshold may be based on a sensor 210 of each of the one or more child wireless devices 115-b equally dividing a FOV to capture 360 degree video or image content. In some examples, the setup threshold may be based on other divisions of the FOV (such as divisions for panorama content capture and 360 degree content capture may be different). Additionally, or alternatively, the setup threshold may be based on identical settings or presets of the one or more child wireless devices 115-b and parent wireless device 115-a.

In some examples, the setup threshold may not be satisfied based on a movement of the one or more child wireless devices 115-b. In such examples, the parent wireless device 115-a may perform the edge detection algorithm or calculate the one or more alignment differences 220 and may transmit a second adjustment information indication. The parent wireless device 115-a may iteratively transmit adjustment information indications based on one or more alignment differences 220 between an image 215 of the parent wireless device 115-a and an image 225 of the child wireless device 115-b until the images are aligned.

In some examples, the parent wireless device 115-a and the one or more child wireless devices 115-b may perform content capture. For example, the one or more child wireless devices 115-b may perform content capture based on the movement of the one or more child wireless devices 115-b satisfying the setup threshold. In some examples, the parent wireless device 115-a may combine the content captured by the parent wireless device 115-a and the one or more child wireless devices 115-b, which may be referred to as composite content capture. For example, the parent wireless device 115-a may combine the second image 215-b and the second image 225-b to generate a full image. Composite content capture may refer to a composition of two or more images, frames (such as captured for a video), or both captured by one or more sensors 210 (such as a camera or video recorder). In some aspects, a frame may be an image. For example, a frame may be an image of a set of contiguous images that, when viewed consecutively, may form a video. In some examples, a composition of the two or more images may refer to a combination of the two or more images. For example, each of the two or more images may be combined (such as stitched) to form a composite image. Additionally, or alternatively, at least a portion of each of the two or more images may be combined to form the composite image (such as a top half of a first image may be combined with a bottom half of a second image). The parent wireless device 115-a and the one or more child wireless devices 115-b may thereby exchange signaling, such as the capability messages 235, the adjustment information indication 240, or both, to facilitate relatively efficient and accurate alignment of images captured by each of the devices. The parent wireless device 115-a may perform composite content capture by combining the adjusted images obtained by each of the child wireless devices 115-b, which may provide for the devices to support capture of 360 degree or panoramic content.

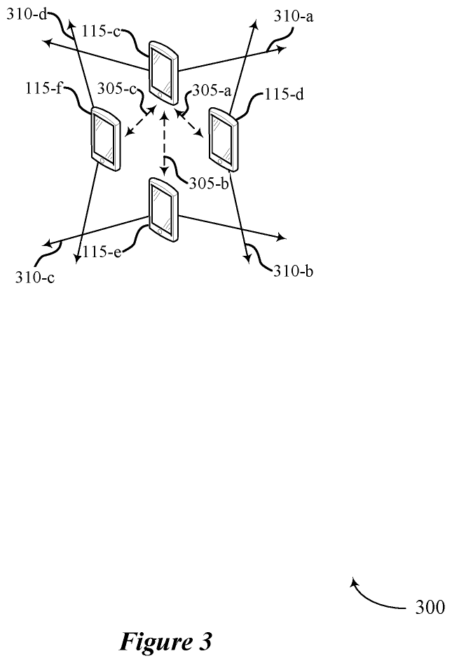

FIG. 3 shows an example of a wireless device configuration 300 that supports composite content capture across multiple wireless devices. FIG. 3 may implement or be implemented by aspects of the wireless communication network 100, the signaling diagram 200, or both, as described with reference to FIGS. 1 and 2. For example, FIG. 3 illustrates a non-limiting example of a parent wireless device 115-c and three child wireless devices: wireless device 115-d, wireless device 115-e, and wireless device 115-f, positioned for 360 degree composite content capture. The wireless devices 115 may represent examples of wireless devices (such as APs, STAs, UEs, network entities, or the like) as described with reference to FIGS. 1 and 2. In some examples, 360 degree composite content capture may be based on the process described in greater detail with reference to FIG. 2 (such as connect and establish, correct and setup, record and process).

For example, the parent wireless device 115-c may establish a two-way-communication link 305-a with child wireless device 115-d, a two-way-communication link 305-b with child wireless device 115-e, and a two-way-communication link 305-c with child wireless device 115-f. In some examples, the parent wireless device 115-c may establish each of the two-way-communication links 305 via a DCF or some other communication protocol. In some examples, each of the child wireless devices 115-d, 115-e, and 115-f may communicate respective sensor capabilities to the parent wireless device 115-c via each of the two-way-communication links 305 (such as described with greater detail to FIG. 2). The child wireless devices 115-d, 115-e, and 115-f may capture content via one or more sensors according to an indication of one or more parameters based on the parent wireless device 115-a receiving the respective sensor capabilities.

In some examples, one or more features of one or more images from the parent wireless device 115-c may not align with one or more features of one or more images from each of the child wireless devices 115-d, 115-e, and 115-f. For example, an image captured by the child wireless device 115-d may not align with an image captured by the parent wireless device 115-c. Additionally, or alternatively, an image captured by the wireless device 115-e may not align with an image captured by the child wireless device 115-d, the child wireless device 115-f, or both. In some examples, an alignment of the images of the parent wireless device 115-c and the child wireless devices 115-d, 115-e, and 115-f may correspond to a FOV 310 of each of the parent wireless device 115-c and the child wireless devices 115-d, 115-e, and 115-f. For example, the alignment of the images may be based on an overlap between a first FOV of a parent device or child device and a second FOV of a child device.

The parent wireless device 115-c may transmit a respective adjustment information indication to each of the child wireless devices 115-d, 115-e, and 115-f, as described with reference to FIG. 2. In some examples, the respective adjustment information indication may correspond to the FOV 310 of each of the parent wireless device 115-c and the child wireless devices 115-d, 115-e, and 115-f. For example, the adjustment information indication may indicate one or more of the child wireless devices 115-d, 115-e, and 115-f to move such that the parent FOV 310-a and the respective child FOVs 310-b, 310-c, and 310-d are equally divided for the 360 degree content capture. In some examples, the FOV 310-a may include a range of 0°-120°, the FOV 310-b may include a range of 90°-210°, the FOV 310-c may include a range of 180°-300°, and the FOV 310-d may include a range of 270°-30°, such that the combined FOV across all of the devices may be approximately 390° (360°+30°_. In some examples, the parent wireless device 115-c may composite the content captured from each of the child wireless devices 115-d, 115-e, and 115-f and output 360 degree content (as described with reference to FIG. 2).

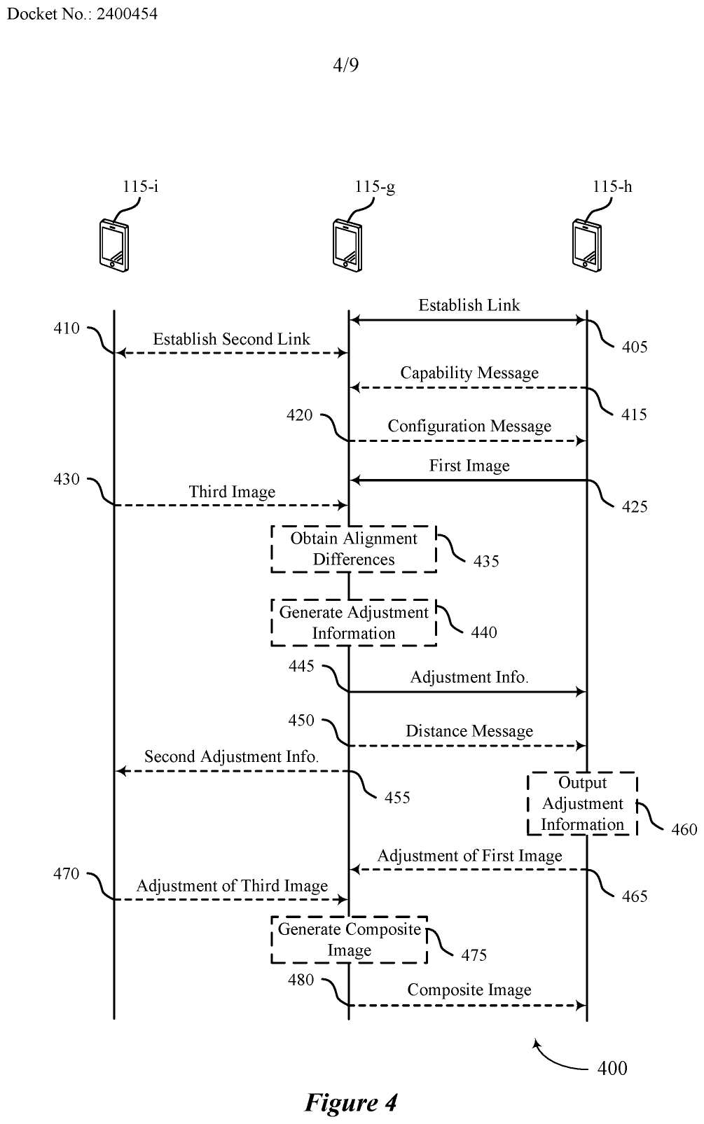

FIG. 4 shows an example of a process flow 400 that supports composite content capture across multiple wireless devices. The process flow 400 may be implement or be implemented by aspects of the wireless communication network 100, the signaling diagram 200, or the wireless device configuration 300 as described herein with reference to FIGS. 1, 2, and 3. For example, a wireless device 115-g, a wireless device 115-h, and a wireless device 115-i, which may be examples of an AP 102 or STA 104 as described herein, may perform aspects of the process flow 400. In the following description of the process flow 400, operations performed by the wireless device 115-g, the wireless device 115-h, and the wireless device 115-i may be performed in a different order than is shown. Some operations may be omitted from the process flow 400, and other operations may be added to the process flow 400. Further, although some operations or signaling may be shown to occur at different times for discussion purposes, these operations may occur at the same time.

At 405, the wireless device 115-g (such as a parent wireless device 115 as described with reference to the wireless device 115-a in FIG. 2 and/or the wireless device 115-c in FIG. 3) may establish a wireless communication link with the wireless device 115-h (such as a child wireless device 115-b as described with reference to the wireless device 115-b in FIG. 2) based on a composite content capture associated with the wireless device 115-g and the wireless device 115-h. In some examples, at 410, the wireless device 115-g may establish a second wireless communication link with the wireless device 115-i (such as a child wireless device 115-b) based on the composite content capture associated with the wireless device 115-g and the wireless device 115-h. In some examples, the first wireless communication link, the second wireless communication link, or both may be established via a DCF.

At 415, the wireless device 115-g may receive, via the wireless communication link, at least one capability message including one or more parameters associated with a sensor at the wireless device 115-h. In some examples, at 420, the wireless device 115-g may transmit, via the wireless communication link based on the one or more parameters indicated via the capability message, a content capture configuration message including the one or more content capture parameters for the composite content capture. The one or more content capture parameters may include one or more of a tone, an aspect ratio, a resolution, a content capture rate, or any combination thereof. In some examples, a first image captured by the sensor of the wireless device 115-h may be based on the content capture configuration message. For example, the first image may be captured by the sensor according to a tone, an aspect ratio, a resolution, or content capture rate parameter included in the content capture configuration message.

At 425, the wireless device 115-g may receive, via the wireless communication link and according to the one or more content capture parameters associated with the wireless device 115-g and the wireless device 115-h, the first image captured by the sensor at the wireless device 115-h. In some examples, the first image may include a first video. In such examples, receiving the first image may include receiving a live stream of the first video.

At 430, the wireless device 115-g may receive, via the second wireless communication link, a third image captured by a third sensor at the wireless device 115-i. In some examples, the sensor at the wireless device 115-h may be associated with a second FOV that is at least partially overlapping with a third FOV associated with the third sensor at the wireless device 115-i. Additionally, or alternatively, the third sensor at the wireless device 115-i may capture the third image based on the wireless device 115-i receiving the content capture configuration message.

At 435, the wireless device 115-g may obtain one or more alignment differences between the first image and a second image. In some aspects, the second image may include a second video. In some examples, the second image may be captured by a second sensor at the wireless device 115-g or by a third sensor at a third wireless device 115 (such as the wireless device 115-i). In some examples, each of the one or more alignment differences may include a respective distance between a first pixel in the first image and a corresponding second pixel in the second image exceeding a threshold distance.

In some examples, at 440, the wireless device 115-g may generate adjustment information based on an ID of the wireless device 115-h. For example, the ID of the wireless device 115-h may indicate an order of the position of the sensor at the wireless device 115-h for the composite content capture. At 445, the wireless device 115-g may transmit, via the wireless communication link based on the one or more alignment differences between the first image and the second image, the adjustment information that may indicate one or more adjustment parameters for adjustment of a position of the sensor of the wireless device 115-h based on the one or more alignment differences between the first image and the second image. In some examples, at 450, the wireless device 115-g may transmit a distance associated with the adjustment of the position of the sensor at the wireless device 115-h, where the distance is based on the respective distance between the first pixel in the first image and the corresponding second pixel in the second image.

At 455, the wireless device 115-g may transmit, via the second wireless communication link based on one or more second alignment differences between the first image and the third image, second adjustment information that may indicate one or more second adjustment parameters for adjustment of a position of the wireless device 115-i based on the one or more second alignment differences between the first image and the second image.

At 460, the wireless device 115-h may output, to a user interface of the second wireless device, the adjustment information. At 465, the wireless device 115-h may transmit, via the wireless communication link based on the adjustment information, an adjustment of the first image associated with the wireless device 115-h. In some examples, the adjustment of the first image may be based on outputting the adjustment information via the user interface.

At 470, the wireless device 115-h may receive, via the second wireless communication link based on the second adjustment information, an adjustment of the third image. At 475, the wireless device 115-g may generate a composite image based on the second image and the adjustment of the first image. Additionally, or alternatively, the composite image may be further based on a concatenation of the second image, the adjustment of the first image, and the adjustment of the third image.

At 480, the wireless device 115-g may transmit, via the wireless communication link, the composite image. In some examples, the wireless device 115-g may capture the second image. In some examples, the composite image includes a 360 degree view associated with a position of the wireless device 115-g and the position of the wireless device 115-h.

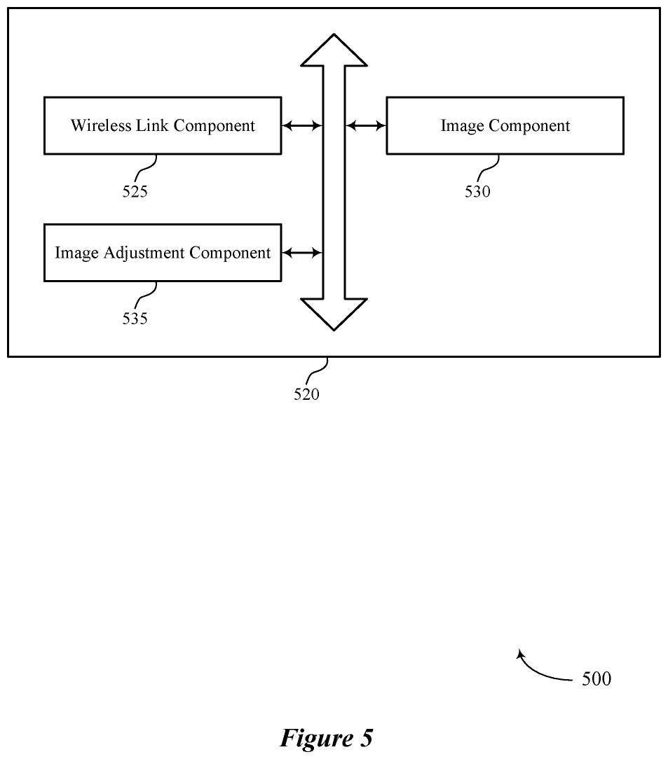

FIG. 5 shows a block diagram 500 of a wireless device 520 that supports composite content capture across multiple wireless devices. The wireless device 520 may be an example of aspects of a wireless device as described with reference to FIGS. 1 through 4. The wireless device 520, or various components thereof, may be an example of means for performing various aspects of composite content capture across multiple wireless devices as described herein. For example, the wireless device 520 may include a Wireless Link Component 525, an Image Component 530, an Image Adjustment Component 535, or any combination thereof. Each of these components, or components or subcomponents thereof (such as one or more processors such as processors including processor circuitry, one or more memories), may communicate, directly or indirectly, with one another (such as via one or more buses).

The wireless communication device 520 may support wireless communications in accordance with examples as disclosed herein. The Wireless Link Component 525 is configurable or configured to establish a wireless communication link with a second wireless device based on a composite content capture associated with the first wireless device and the second wireless device. The Image Component 530 is configurable or configured to receive, via the wireless communication link and according to one or more content capture parameters associated with the first wireless device and the second wireless device, a first image captured by a sensor at the second wireless device. The Image Adjustment Component 535 is configurable or configured to transmit, via the wireless communication link based on one or more alignment differences between the first image and a second image, adjustment information that indicates one or more adjustment parameters for adjustment of a position of the sensor of the second wireless device based on the one or more alignment differences between the first image and the second image.

In some examples, the Image Component 530 is configurable or configured to receive, via the wireless communication link, at least one capability message including one or more parameters associated with the sensor at the second wireless device. In some examples, the Image Component 530 is configurable or configured to transmit, via the wireless communication link based on the one or more parameters indicated via the capability message, a content capture configuration message including the one or more content capture parameters for the composite content capture, where the first image captured by the sensor at the second wireless device is based on the content capture configuration message.

In some examples, the Wireless Link Component 525 is configurable or configured to receive, via the wireless communication link based on the adjustment information, an adjustment of the first image associated with the second wireless device. In some examples, the Image Component 530 is configurable or configured to generate a composite image based on the second image and the adjustment of the first image.

In some examples, the Wireless Link Component 525 is configurable or configured to transmit, via the wireless communication link, the composite image, where the first wireless device captures the second image, and where the composite image includes a 360 degree view associated with a position of the first wireless device and the position of the second wireless device.

In some examples, the Wireless Link Component 525 is configurable or configured to establish a second wireless communication link with a third wireless device based on the composite content capture associated with the first wireless device and the second wireless device. In some examples, the Image Component 530 is configurable or configured to receive, via the second wireless communication link, a third image captured by a third sensor at the third wireless device, where the sensor at the second wireless device is associated with a second field of view that is at least partially overlapping with a third field of view associated with the third sensor at the third wireless device. In some examples, the Image Adjustment Component 535 is configurable or configured to transmit, via the second wireless communication link based on one or more second alignment differences between the first image and the third image, second adjustment information that indicates one or more second adjustment parameters for adjustment of a position of the third wireless device based on the one or more second alignment differences between the first image and the second image. In some examples, the Wireless Link Component 525 is configurable or configured to receive, via the second wireless communication link based on the adjustment information, an adjustment of the third image, where the composite image is further based on a concatenation of the second image, the adjustment of the first image, and the adjustment of the third image.

In some examples, the Image Adjustment Component 535 is configurable or configured to obtain the one or more alignment differences between the first image and the second image, where each of the one or more alignment differences includes a respective distance between a first pixel in the first image and a corresponding second pixel in the second image exceeding a threshold distance.

In some examples, to support transmitting the adjustment information, the Image Adjustment Component 535 is configurable or configured to transmit, via the wireless communication link, a distance associated with the adjustment of the position of the sensor at the second wireless device, where the distance is based on the respective distance between the first pixel in the first image and the corresponding second pixel in the second image.

In some examples, the Image Adjustment Component 535 is configurable or configured to generate the adjustment information based on an ID of the second wireless device, where the ID of the second wireless device indicates an order of the position of the sensor at the second wireless device for the composite content capture.

In some examples, the one or more content capture parameters associated with the first wireless device and the second wireless device include one or more of a tone, an aspect ratio, a resolution, a content capture rate, or any combination thereof.

In some examples, the Image Component 530 is configurable or configured to the first image include a first video. In some examples, the Image Component 530 is configurable or configured to the second image include a second video. In some examples, the Image Component 530 is configurable or configured to receive the first image includes receiving a live stream of the first video. In some examples, the second image is captured by a second sensor at the first wireless device or by a third sensor at a third wireless device. In some examples, the wireless communication link is established via a distributed coordination function.

Additionally, or alternatively, the wireless communication device 520 may support wireless communications in accordance with examples as disclosed herein. In some examples, the Wireless Link Component 525 is configurable or configured to establish a wireless communication link with a first wireless device based on a composite content capture associated with the first wireless device and the second wireless device. In some examples, the Image Component 530 is configurable or configured to transmit, via the wireless communication link and according to one or more content capture parameters associated with the first wireless device and the second wireless device, a first image captured by a sensor at the second wireless device. In some examples, the Image Adjustment Component 535 is configurable or configured to receive, via the wireless communication link based on one or more alignment differences between the first image and a second image, adjustment information that indicates one or more adjustment parameters for adjustment of a position of the sensor at the second wireless device based on the one or more alignment differences between the first image and the second image.

In some examples, the Image Component 530 is configurable or configured to transmit, via the wireless communication link, a capability message including one or more parameters associated with the sensor at the second wireless device. In some examples, the Image Component 530 is configurable or configured to receive, via the wireless communication link based on the one or more parameters indicated via the capability message, a content capture configuration message including the one or more content capture parameters for the composite content capture, where the first image captured by the sensor at the second wireless device is based on the content capture configuration message.

In some examples, the Image Adjustment Component 535 is configurable or configured to output, to a user interface of the second wireless device, the adjustment information. In some examples, the Wireless Link Component 525 is configurable or configured to transmit, via the wireless communication link based on the adjustment information, an adjustment of the first image associated with the second wireless device, the adjustment of the first image based on outputting the adjustment information via the user interface.

In some examples, the Wireless Link Component 525 is configurable or configured to receive, via the wireless communication link, a composite image based on a concatenation of the second image and the adjustment of the first image, where the first wireless device captures the second image, and where the composite image includes a 360 degree view associated with a position of the first wireless device and the position of the sensor at the second wireless device.

In some examples, to support receiving the adjustment information, the Image Adjustment Component 535 is configurable or configured to receive, via the wireless communication link, a distance associated with the adjustment of the position of the sensor at the second wireless device, where the distance is based on a respective distance between a first pixel in the first image and a corresponding second pixel in the second image. In some examples, the one or more content capture parameters associated with the first wireless device and the second wireless device include one or more parameters associated with a tone, an aspect ratio, a resolution, a content capture rate, or any combination thereof.

In some examples, the first image includes a first video. In some examples, the second image includes a second video. In some examples, transmitting the first image includes transmitting a live stream of the first video. In some examples, the second image is captured by a second sensor at the first wireless device or by a third sensor at a third wireless device. In some examples, the wireless communication link is established via a distributed coordination function.

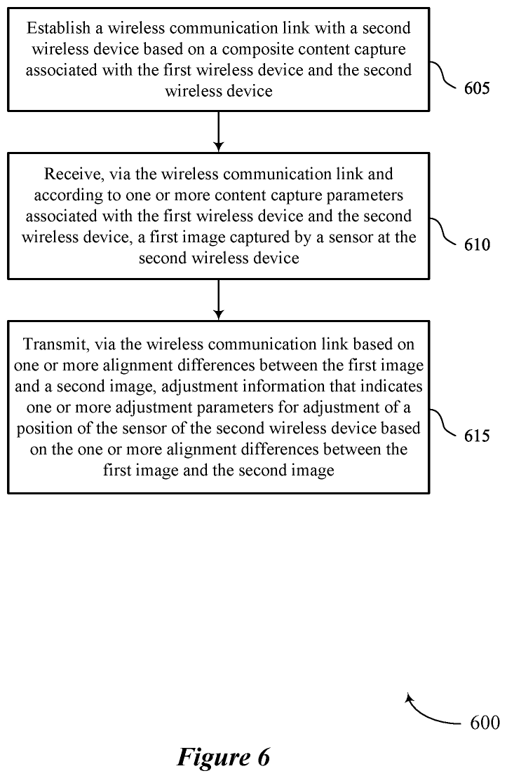

FIG. 6 shows a flowchart illustrating a method 600 that supports composite content capture across multiple wireless devices. The operations of the method 600 may be implemented by a wireless device or its components as described herein. For example, the operations of the method 600 may be performed by a wireless device as described with reference to FIGS. 1 through 5. In some examples, a wireless device may execute a set of instructions to control the functional elements of the wireless device to perform the described functions. Additionally, or alternatively, the wireless device may perform aspects of the described functions using special-purpose hardware.

At 605, the method may include establishing a wireless communication link with a second wireless device based on a composite content capture associated with the first wireless device and the second wireless device. The operations of 605 may be performed in accordance with examples as disclosed herein. In some examples, aspects of the operations of 605 may be performed by a Wireless Link Component 525 as described with reference to FIG. 5.

At 610, the method may include receiving, via the wireless communication link and according to one or more content capture parameters associated with the first wireless device and the second wireless device, a first image captured by a sensor at the second wireless device. The operations of 610 may be performed in accordance with examples as disclosed herein. In some examples, aspects of the operations of 610 may be performed by an Image Component 530 as described with reference to FIG. 5.

At 615, the method may include transmitting, via the wireless communication link based on one or more alignment differences between the first image and a second image, adjustment information that indicates one or more adjustment parameters for adjustment of a position of the sensor of the second wireless device based on the one or more alignment differences between the first image and the second image. The operations of 615 may be performed in accordance with examples as disclosed herein. In some examples, aspects of the operations of 615 may be performed by an Image Adjustment Component 535 as described with reference to FIG. 5.

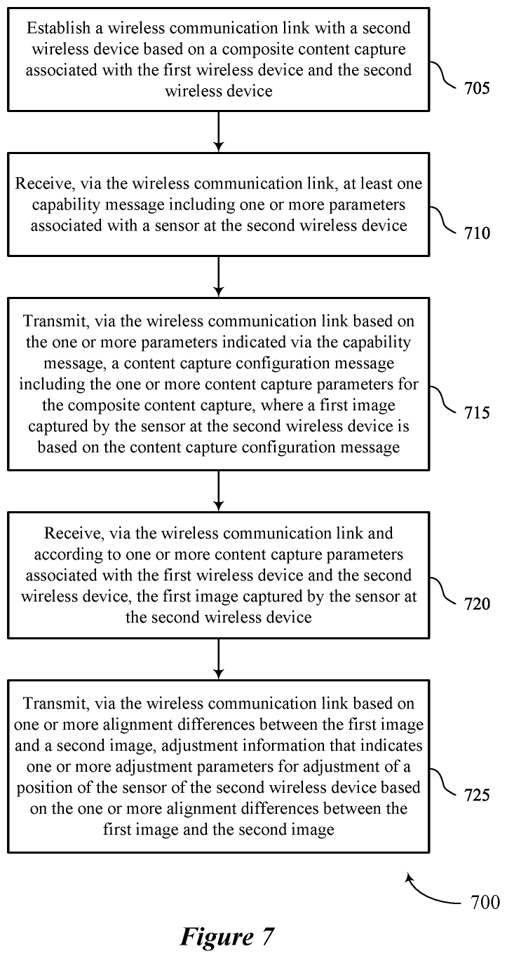

FIG. 7 shows a flowchart illustrating a method 700 that supports composite content capture across multiple wireless devices. The operations of the method 700 may be implemented by a wireless device or its components as described herein. For example, the operations of the method 700 may be performed by a wireless device as described with reference to FIGS. 1 through 5. In some examples, a wireless device may execute a set of instructions to control the functional elements of the wireless device to perform the described functions. Additionally, or alternatively, the wireless device may perform aspects of the described functions using special-purpose hardware.

At 705, the method may include establishing a wireless communication link with a second wireless device based on a composite content capture associated with the first wireless device and the second wireless device. The operations of 705 may be performed in accordance with examples as disclosed herein. In some examples, aspects of the operations of 705 may be performed by a Wireless Link Component 525 as described with reference to FIG. 5.

At 710, the method may include receiving, via the wireless communication link, at least one capability message including one or more parameters associated with a sensor at the second wireless device. The operations of 710 may be performed in accordance with examples as disclosed herein. In some examples, aspects of the operations of 710 may be performed by an Image Component 530 as described with reference to FIG. 5.

At 715, the method may include transmitting, via the wireless communication link based on the one or more parameters indicated via the capability message, a content capture configuration message including the one or more content capture parameters for the composite content capture, where a first image captured by the sensor at the second wireless device is based on the content capture configuration message. The operations of 715 may be performed in accordance with examples as disclosed herein. In some examples, aspects of the operations of 715 may be performed by an Image Component 530 as described with reference to FIG. 5.

At 720, the method may include receiving, via the wireless communication link and according to one or more content capture parameters associated with the first wireless device and the second wireless device, the first image captured by the sensor at the second wireless device. The operations of 720 may be performed in accordance with examples as disclosed herein. In some examples, aspects of the operations of 720 may be performed by an Image Component 530 as described with reference to FIG. 5.

At 725, the method may include transmitting, via the wireless communication link based on one or more alignment differences between the first image and a second image, adjustment information that indicates one or more adjustment parameters for adjustment of a position of the sensor of the second wireless device based on the one or more alignment differences between the first image and the second image. The operations of 725 may be performed in accordance with examples as disclosed herein. In some examples, aspects of the operations of 725 may be performed by an Image Adjustment Component 535 as described with reference to FIG. 5.

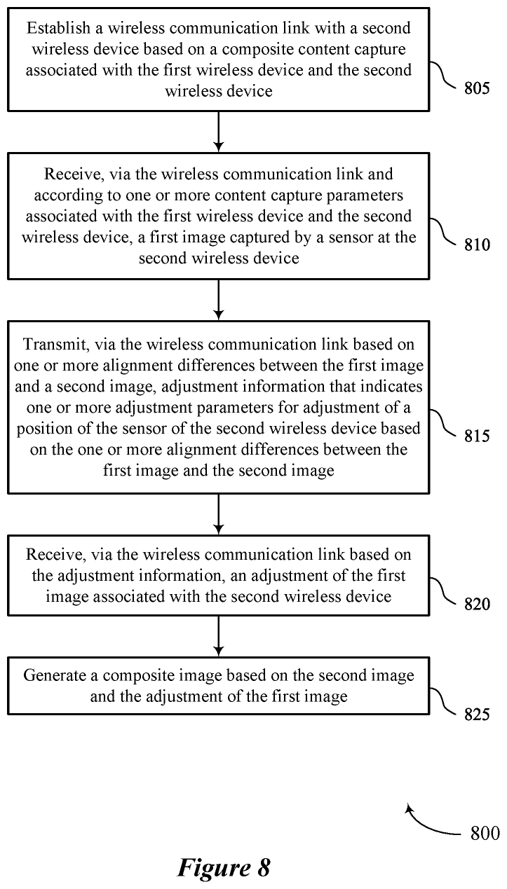

FIG. 8 shows a flowchart illustrating a method 800 that supports composite content capture across multiple wireless devices. The operations of the method 800 may be implemented by a wireless device or its components as described herein. For example, the operations of the method 800 may be performed by a wireless device as described with reference to FIGS. 1 through 5. In some examples, a wireless device may execute a set of instructions to control the functional elements of the wireless device to perform the described functions. Additionally, or alternatively, the wireless device may perform aspects of the described functions using special-purpose hardware.

At 805, the method may include establishing a wireless communication link with a second wireless device based on a composite content capture associated with the first wireless device and the second wireless device. The operations of 805 may be performed in accordance with examples as disclosed herein. In some examples, aspects of the operations of 805 may be performed by a Wireless Link Component 525 as described with reference to FIG. 5.

At 810, the method may include receiving, via the wireless communication link and according to one or more content capture parameters associated with the first wireless device and the second wireless device, a first image captured by a sensor at the second wireless device. The operations of 810 may be performed in accordance with examples as disclosed herein. In some examples, aspects of the operations of 810 may be performed by an Image Component 530 as described with reference to FIG. 5.

At 815, the method may include transmitting, via the wireless communication link based on one or more alignment differences between the first image and a second image, adjustment information that indicates one or more adjustment parameters for adjustment of a position of the sensor of the second wireless device based on the one or more alignment differences between the first image and the second image. The operations of 815 may be performed in accordance with examples as disclosed herein. In some examples, aspects of the operations of 815 may be performed by an Image Adjustment Component 535 as described with reference to FIG. 5.

At 820, the method may include receiving, via the wireless communication link based on the adjustment information, an adjustment of the first image associated with the second wireless device. The operations of 820 may be performed in accordance with examples as disclosed herein. In some examples, aspects of the operations of 820 may be performed by a Wireless Link Component 525 as described with reference to FIG. 5.

At 825, the method may include generating a composite image based on the second image and the adjustment of the first image. The operations of 825 may be performed in accordance with examples as disclosed herein. In some examples, aspects of the operations of 825 may be performed by an Image Component 530 as described with reference to FIG. 5.

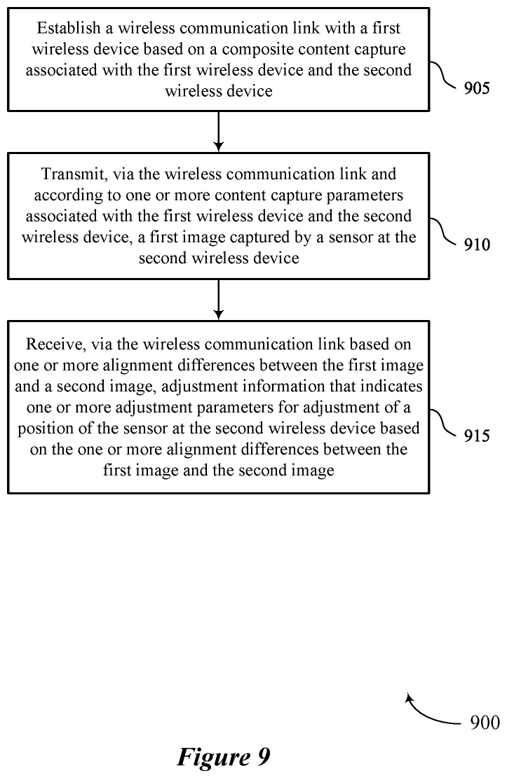

FIG. 9 shows a flowchart illustrating a method 900 that supports composite content capture across multiple wireless devices. The operations of the method 900 may be implemented by a wireless device (such as a UE, a STA 104, or an AP 102) or its components as described herein. For example, the operations of the method 900 may be performed by a wireless device as described with reference to FIGS. 1 through 5. In some examples, a wireless device may execute a set of instructions to control the functional elements of the wireless device to perform the described functions. Additionally, or alternatively, the wireless device may perform aspects of the described functions using special-purpose hardware.

At 905, the method may include establishing a wireless communication link with a first wireless device based on a composite content capture associated with the first wireless device and the second wireless device. The operations of 905 may be performed in accordance with examples as disclosed herein. In some examples, aspects of the operations of 905 may be performed by a Wireless Link Component 525 as described with reference to FIG. 5.

At 910, the method may include transmitting, via the wireless communication link and according to one or more content capture parameters associated with the first wireless device and the second wireless device, a first image captured by a sensor at the second wireless device. The operations of 910 may be performed in accordance with examples as disclosed herein. In some examples, aspects of the operations of 910 may be performed by an Image Component 530 as described with reference to FIG. 5.

At 915, the method may include receiving, via the wireless communication link based on one or more alignment differences between the first image and a second image, adjustment information that indicates one or more adjustment parameters for adjustment of a position of the sensor at the second wireless device based on the one or more alignment differences between the first image and the second image. The operations of 915 may be performed in accordance with examples as disclosed herein. In some examples, aspects of the operations of 915 may be performed by an Image Adjustment Component 535 as described with reference to FIG. 5.

Implementation examples are described in the following numbered clauses:

Clause 1: A method for wireless communications at a first wireless device, including: establishing a wireless communication link with a second wireless device based at least in part on a composite content capture associated with the first wireless device and the second wireless device; receiving, via the wireless communication link and according to one or more content capture parameters associated with the first wireless device and the second wireless device, a first image captured by a sensor at the second wireless device; and transmitting, via the wireless communication link based at least in part on one or more alignment differences between the first image and a second image, adjustment information that indicates one or more adjustment parameters for adjustment of a position of the sensor of the second wireless device based at least in part on the one or more alignment differences between the first image and the second image.

Clause 2: The method of clause 1, further including: receiving, via the wireless communication link, at least one capability message including one or more parameters associated with the sensor at the second wireless device; and transmitting, via the wireless communication link based at least in part on the one or more parameters indicated via the capability message, a content capture configuration message including the one or more content capture parameters for the composite content capture, where the first image captured by the sensor at the second wireless device is based at least in part on the content capture configuration message.

Clause 3: The method of any of clauses 1 through 2, further including: receiving, via the wireless communication link based at least in part on the adjustment information, an adjustment of the first image associated with the second wireless device; and generating a composite image based at least in part on the second image and the adjustment of the first image.

Clause 4: The method of clause 3, further including: transmitting, via the wireless communication link, the composite image, where the first wireless device captures the second image, and where the composite image includes a 360 degree view associated with a position of the first wireless device and the position of the second wireless device.

Clause 5: The method of any of clauses 3 through 4, further including: establishing a second wireless communication link with a third wireless device based at least in part on the composite content capture associated with the first wireless device and the second wireless device; receiving, via the second wireless communication link, a third image captured by a third sensor at the third wireless device, where the sensor at the second wireless device is associated with a second field of view that is at least partially overlapping with a third field of view associated with the third sensor at the third wireless device; transmitting, via the second wireless communication link based at least in part on one or more second alignment differences between the first image and the third image, second adjustment information that indicates one or more second adjustment parameters for adjustment of a position of the third wireless device based at least in part on the one or more second alignment differences between the first image and the second image; and receiving, via the second wireless communication link based at least in part on the adjustment information, an adjustment of the third image, where the composite image is further based at least in part on a concatenation of the second image, the adjustment of the first image, and the adjustment of the third image.

Clause 6: The method of any of clauses 1 through 5, further including: obtaining the one or more alignment differences between the first image and the second image, where each of the one or more alignment differences includes a respective distance between a first pixel in the first image and a corresponding second pixel in the second image exceeding a threshold distance.

Clause 7: The method of clause 6, where transmitting the adjustment information includes: transmitting, via the wireless communication link, a distance associated with the adjustment of the position of the sensor at the second wireless device, where the distance is based at least in part on the respective distance between the first pixel in the first image and the corresponding second pixel in the second image.

Clause 8: The method of any of clauses 1 through 7, further including: generating the adjustment information based at least in part on an identifier of the second wireless device, where the identifier of the second wireless device indicates an order of the position of the sensor at the second wireless device for the composite content capture.

Clause 9: The method of any of clauses 1 through 8, where the one or more content capture parameters associated with the first wireless device and the second wireless device include one or more of a tone, an clause ratio, a resolution, a content capture rate, or any combination thereof.

Clause 10: The method of any of clauses 1 through 9, further including: the first image includes a first video; the second image includes a second video; and receiving the first image includes receiving a live stream of the first video.

Clause 11: The method of any of clauses 1 through 10, where the second image is captured by a second sensor at the first wireless device or by a third sensor at a third wireless device.

Clause 12: The method of any of clauses 1 through 11, where the wireless communication link is established via a distributed coordination function.

Clause 13: A method for wireless communications at a second wireless device, including: establishing a wireless communication link with a first wireless device based at least in part on a composite content capture associated with the first wireless device and the second wireless device; transmitting, via the wireless communication link and according to one or more content capture parameters associated with the first wireless device and the second wireless device, a first image captured by a sensor at the second wireless device; and receiving, via the wireless communication link based at least in part on one or more alignment differences between the first image and a second image, adjustment information that indicates one or more adjustment parameters for adjustment of a position of the sensor at the second wireless device based at least in part on the one or more alignment differences between the first image and the second image.

Clause 14: The method of clause 13, further including: transmitting, via the wireless communication link, a capability message including one or more parameters associated with the sensor at the second wireless device; and receiving, via the wireless communication link based at least in part on the one or more parameters indicated via the capability message, a content capture configuration message including the one or more content capture parameters for the composite content capture, where the first image captured by the sensor at the second wireless device is based at least in part on the content capture configuration message.

Clause 15: The method of any of clauses 13 through 14, further including: outputting, to a user interface of the second wireless device, the adjustment information; and transmitting, via the wireless communication link based at least in part on the adjustment information, an adjustment of the first image associated with the second wireless device, the adjustment of the first image based at least in part on outputting the adjustment information via the user interface.

Clause 16: The method of clause 15, further including: receiving, via the wireless communication link, a composite image based at least in part on a concatenation of the second image and the adjustment of the first image, where the first wireless device captures the second image, and where the composite image includes a 360 degree view associated with a position of the first wireless device and the position of the sensor at the second wireless device.

Clause 17: The method of any of clauses 13 through 16, where receiving the adjustment information includes: receiving, via the wireless communication link, a distance associated with the adjustment of the position of the sensor at the second wireless device, where the distance is based at least in part on a respective distance between a first pixel in the first image and a corresponding second pixel in the second image.

Clause 18: The method of any of clauses 13 through 17, where the one or more content capture parameters associated with the first wireless device and the second wireless device include one or more parameters associated with a tone, an clause ratio, a resolution, a content capture rate, or any combination thereof.

Clause 19: The method of any of clauses 13 through 18, where the first image includes a first video; the second image includes a second video; and transmitting the first image includes transmitting a live stream of the first video.

Clause 20: The method of any of clauses 13 through 19, where the second image is captured by a second sensor at the first wireless device or by a third sensor at a third wireless device.

Clause 21: The method of any of clauses 13 through 20, where the wireless communication link is established via a distributed coordination function.

Clause 22: A first wireless device for wireless communications, including one or more memories storing processor-executable code, and one or more processors coupled with the one or more memories and individually or collectively operable to execute the code to cause the first wireless device to perform a method of any of clauses 1 through 12.

Clause 23: A first wireless device for wireless communications, including at least one means for performing a method of any of clauses 1 through 12.

Clause 24: A non-transitory computer-readable medium storing code for wireless communications, the code including instructions executable by one or more processors to perform a method of any of clauses 1 through 12.

Clause 25: A second wireless device for wireless communications, including one or more memories storing processor-executable code, and one or more processors coupled with the one or more memories and individually or collectively operable to execute the code to cause the second wireless device to perform a method of any of clauses 13 through 21.

Clause 26: A second wireless device for wireless communications, including at least one means for performing a method of any of clauses 13 through 21.

Clause 27: A non-transitory computer-readable medium storing code for wireless communications, the code including instructions executable by one or more processors to perform a method of any of clauses 13 through 21.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A first wireless device, comprising:
a processing system that includes processor circuitry and memory circuitry that stores code, the processing system configured to cause the first wireless device to:
establish a wireless communication link with a second wireless device based at least in part on a composite content capture associated with the first wireless device and the second wireless device;
receive, via the wireless communication link and according to one or more content capture parameters associated with the first wireless device and the second wireless device, a first image captured by a sensor at the second wireless device; and
transmit, via the wireless communication link based at least in part on one or more alignment differences between the first image and a second image, adjustment information that indicates one or more adjustment parameters for adjustment of a position of the sensor of the second wireless device based at least in part on the one or more alignment differences between the first image and the second image.

2. The first wireless device of claim 1, wherein the processing system is further configured to cause the first wireless device to:
receive, via the wireless communication link, at least one capability message comprising one or more parameters associated with the sensor at the second wireless device; and
transmit, via the wireless communication link based at least in part on the one or more parameters indicated via the capability message, a content capture configuration message comprising the one or more content capture parameters for the composite content capture, wherein the first image captured by the sensor at the second wireless device is based at least in part on the content capture configuration message.

3. The first wireless device of claim 1, wherein the processing system is further configured to cause the first wireless device to:
receive, via the wireless communication link based at least in part on the adjustment information, an adjustment of the first image associated with the second wireless device; and
generate a composite image based at least in part on the second image and the adjustment of the first image.

4. The first wireless device of claim 3, wherein the processing system is further configured to cause the first wireless device to:
transmit, via the wireless communication link, the composite image, wherein the first wireless device captures the second image, and wherein the composite image comprises a 360 degree view associated with a position of the first wireless device and the position of the second wireless device.

5. The first wireless device of claim 3, wherein the processing system is further configured to cause the first wireless device to:
establish a second wireless communication link with a third wireless device based at least in part on the composite content capture associated with the first wireless device and the second wireless device;
receive, via the second wireless communication link, a third image captured by a third sensor at the third wireless device, wherein the sensor at the second wireless device is associated with a second field of view that is at least partially overlapping with a third field of view associated with the third sensor at the third wireless device;
transmit, via the second wireless communication link based at least in part on one or more second alignment differences between the first image and the third image, second adjustment information that indicates one or more second adjustment parameters for adjustment of a position of the third wireless device based at least in part on the one or more second alignment differences between the first image and the second image; and
receive, via the second wireless communication link based at least in part on the adjustment information, an adjustment of the third image, wherein the composite image is further based at least in part on a concatenation of the second image, the adjustment of the first image, and the adjustment of the third image.

6. The first wireless device of claim 1, wherein the processing system is further configured to cause the first wireless device to:
obtain the one or more alignment differences between the first image and the second image, wherein each of the one or more alignment differences comprises a respective distance between a first pixel in the first image and a corresponding second pixel in the second image exceeding a threshold distance.

7. The first wireless device of claim 6, wherein, to transmit the adjustment information, the processing system is configured to cause the first wireless device to:
transmit, via the wireless communication link, a distance associated with the adjustment of the position of the sensor at the second wireless device, wherein the distance is based at least in part on the respective distance between the first pixel in the first image and the corresponding second pixel in the second image.

8. The first wireless device of claim 1, wherein the processing system is further configured to cause the first wireless device to:
generate the adjustment information based at least in part on an identifier of the second wireless device, wherein the identifier of the second wireless device indicates an order of the position of the sensor at the second wireless device for the composite content capture.

9. The first wireless device of claim 1, wherein the one or more content capture parameters associated with the first wireless device and the second wireless device comprise one or more of a tone, an aspect ratio, a resolution, a content capture rate, or any combination thereof.

10. The first wireless device of claim 1, wherein the processing system is further configured to cause the first wireless device to:
the first image comprise a first video;
the second image comprise a second video; and
receive the first image comprises receiving a live stream of the first video.

11. The first wireless device of claim 1, wherein the second image is captured by a second sensor at the first wireless device or by a third sensor at a third wireless device.

12. The first wireless device of claim 1, wherein the wireless communication link is established via a distributed coordination function.

13. A second wireless device, comprising:
a processing system that includes processor circuitry and memory circuitry that stores code, the processing system configured to cause the second wireless device to:
establish a wireless communication link with a first wireless device based at least in part on a composite content capture associated with the first wireless device and the second wireless device;
transmit, via the wireless communication link and according to one or more content capture parameters associated with the first wireless device and the second wireless device, a first image captured by a sensor at the second wireless device; and
receive, via the wireless communication link based at least in part on one or more alignment differences between the first image and a second image, adjustment information that indicates one or more adjustment parameters for adjustment of a position of the sensor at the second wireless device based at least in part on the one or more alignment differences between the first image and the second image.

14. The second wireless device of claim 13, wherein the processing system is further configured to cause the second wireless device to:
transmit, via the wireless communication link, a capability message comprising one or more parameters associated with the sensor at the second wireless device; and
receive, via the wireless communication link based at least in part on the one or more parameters indicated via the capability message, a content capture configuration message comprising the one or more content capture parameters for the composite content capture, wherein the first image captured by the sensor at the second wireless device is based at least in part on the content capture configuration message.

15. The second wireless device of claim 13, wherein the processing system is further configured to cause the second wireless device to:
output, to a user interface of the second wireless device, the adjustment information; and
transmit, via the wireless communication link based at least in part on the adjustment information, an adjustment of the first image associated with the second wireless device, the adjustment of the first image based at least in part on outputting the adjustment information via the user interface.

16. The second wireless device of claim 15, wherein the processing system is further configured to cause the second wireless device to:
receive, via the wireless communication link, a composite image based at least in part on a concatenation of the second image and the adjustment of the first image, wherein the first wireless device captures the second image, and wherein the composite image comprises a 360 degree view associated with a position of the first wireless device and the position of the sensor at the second wireless device.

17. The second wireless device of claim 13, wherein, to receive the adjustment information, the processing system is configured to cause the second wireless device to:
receive, via the wireless communication link, a distance associated with the adjustment of the position of the sensor at the second wireless device, wherein the distance is based at least in part on a respective distance between a first pixel in the first image and a corresponding second pixel in the second image.

18. The second wireless device of claim 13, wherein the one or more content capture parameters associated with the first wireless device and the second wireless device comprise one or more parameters associated with a tone, an aspect ratio, a resolution, a content capture rate, or any combination thereof.

19. The second wireless device of claim 13, wherein:
the first image comprises a first video;
the second image comprises a second video; and
transmitting the first image comprises transmitting a live stream of the first video.

20. The second wireless device of claim 13, wherein the second image is captured by a second sensor at the first wireless device or by a third sensor at a third wireless device.

21. The second wireless device of claim 13, wherein the wireless communication link is established via a distributed coordination function.

22. A method for wireless communications at a first wireless device, comprising:
establishing a wireless communication link with a second wireless device based at least in part on a composite content capture associated with the first wireless device and the second wireless device;
receiving, via the wireless communication link and according to one or more content capture parameters associated with the first wireless device and the second wireless device, a first image captured by a sensor at the second wireless device; and
transmitting, via the wireless communication link based at least in part on one or more alignment differences between the first image and a second image, adjustment information that indicates one or more adjustment parameters for adjustment of a position of the sensor of the second wireless device based at least in part on the one or more alignment differences between the first image and the second image.

23. The method of claim 22, further comprising:
receiving, via the wireless communication link, at least one capability message comprising one or more parameters associated with the sensor at the second wireless device; and
transmitting, via the wireless communication link based at least in part on the one or more parameters indicated via the capability message, a content capture configuration message comprising the one or more content capture parameters for the composite content capture, wherein the first image captured by the sensor at the second wireless device is based at least in part on the content capture configuration message.

24. The method of claim 22, further comprising:
receiving, via the wireless communication link based at least in part on the adjustment information, an adjustment of the first image associated with the second wireless device; and
generating a composite image based at least in part on the second image and the adjustment of the first image.

25. The method of claim 22, further comprising:
the first image comprises a first video;
the second image comprises a second video; and
receiving the first image comprises receiving a live stream of the first video.

26. A method for wireless communications at a second wireless device, comprising:
establishing a wireless communication link with a first wireless device based at least in part on a composite content capture associated with the first wireless device and the second wireless device;
transmitting, via the wireless communication link and according to one or more content capture parameters associated with the first wireless device and the second wireless device, a first image captured by a sensor at the second wireless device; and
receiving, via the wireless communication link based at least in part on one or more alignment differences between the first image and a second image, adjustment information that indicates one or more adjustment parameters for adjustment of a position of the sensor at the second wireless device based at least in part on the one or more alignment differences between the first image and the second image.

27. The method of claim 26, further comprising:
transmitting, via the wireless communication link, a capability message comprising one or more parameters associated with the sensor at the second wireless device; and
receiving, via the wireless communication link based at least in part on the one or more parameters indicated via the capability message, a content capture configuration message comprising the one or more content capture parameters for the composite content capture, wherein the first image captured by the sensor at the second wireless device is based at least in part on the content capture configuration message.

28. The method of claim 26, further comprising:
outputting, to a user interface of the second wireless device, the adjustment information; and
transmitting, via the wireless communication link based at least in part on the adjustment information, an adjustment of the first image associated with the second wireless device, the adjustment of the first image based at least in part on outputting the adjustment information via the user interface.

29. The method of claim 28, further comprising:
receiving, via the wireless communication link, a composite image based at least in part on a concatenation of the second image and the adjustment of the first image, wherein the first wireless device captures the second image, and wherein the composite image comprises a 360 degree view associated with a position of the first wireless device and the position of the sensor at the second wireless device.

30. The method of claim 26, wherein receiving the adjustment information comprises:
receiving, via the wireless communication link, a distance associated with the adjustment of the position of the sensor at the second wireless device, wherein the distance is based at least in part on a respective distance between a first pixel in the first image and a corresponding second pixel in the second image.
